(19) United States
(12) Patent Application Publication
(10) Pub. No.: US 2016/0375425 A1
(43) Pub. Date: Dec. 29, 2016

(54) Method of Fabricating Annular Carrier Catalyst

(71) Applicant: Institute of Nuclear Energy Research, Atomic Energy Council, Executive Yuan, R.O.C., Taoyuan City (TW)

(72) Inventors: Yi-Si Chou, New Taipei City (TW); Men-Han Huang, Taoyuan City (TW); Ning-Yih Hsu, Keelung City (TW); Ruey-Yi Lee, Taoyuan City (TW); Kin-Fu Lin, Taoyuan City (TW)

(21) Appl. No.: 15/080,676

(22) Filed: Mar. 25, 2016

(30) Foreign Application Priority Data
Jun. 25, 2015 (TW) 104120617

(51) Int. Cl. B01J 23/63; B01J 37/02; B01J 35/10; B01J 37/08

(52) U.S. Cl. CPC B01J 23/63; B01J 37/08; B01J 37/0207; B01J 37/0236; B01J 35/1014; B01J 35/1057

(57) ABSTRACT

A method is provided for fabricating a carrier catalyst. The carrier catalyst uses an annular carrier of α-alumina (α—Al₂O₃). The annular carrier of α—Al₂O₃ has stable activity. By analyzing characteristics and methane conversion rates of catalysts with different compositions, a solution for solving carbon deposition is found. Cerium oxide (CeO₂) is used as an accelerator and platinum (Pt) nano-particles are used as catalyzer. The above components are impregnated and coated on the annular carrier of α—Al₂O₃. Thus, an annular-carrier catalyst of Pt/C_{B}O₂/α—Al₂O₃ is formed. Therein, the present invention uses carbon nanotubes before calcining the annular carrier catalyst. Consequently, its microstructure is modified to obtain a surface area of 130 square meters per gram and an average pore size of 12.585 angstroms. Preferably, 0.5 percents of platinum nano-particles are to be added into the carrier catalyst to achieve a 79% methane conversion rate even after 25 hours of reformation reaction.

### TECHNICAL FIELD OF THE INVENTION

The present invention relates to fabricating an annular carrier catalyst; more particularly, relates to fabricating an annular carrier catalyst of platinum/cerium oxide/α-alumina (Pt/CeO₂/α—Al₂O₃) with the annular carrier of α—Al₂O₃ impregnated and coated with CeO₂ as accelerator and platinum nanoparticles as catalyst for reducing the development cost and obtaining durability of the carrier catalyst.

### DESCRIPTION OF THE RELATED ARTS

Energy demands increase over time as the world is in pursuit of economic growth. However, available stocks of fossil fuels will be dwindled in the foreseeable future. People will face energy cost increase and energy shortage. Moreover, as regulatory requirements over environment are becoming more and more stringent in the world, emissions of greenhouse gases (mainly carbon dioxide (CO₂)) catch the world's attention; and, therefore, urgent demand on high-efficiency, new and clean energy is gradually emerged.

Hydrogen is regarded as a best clean fuel. Though energy conversion, hydrogen energy can be directly turns into electricity and heat at low pollution or zero CO₂ emission. Traditionally, fossil industries use catalysts in the hydrogen-generating reformation to produce gas for increasing production and efficiency.

The traditional chemical raw materials are expanded and the petrochemical industries gradually change the original use of petroleum-based raw materials into natural gas for reducing the exhaust emissions in chemical procedures, enhancing energy efficiency and decreasing the enormous pressure of human existence by eliminating the greenhouse effect. Therefore, catalysts and related catalytic technologies are reported as key technologies of comprehensive energy strategy for energy, environment and sustainable development in reports of the US Department of Energy (DOE).

In the future, catalyst will play a very important role, where water gas shift reaction is a very important process of transformation in the energy field. Therein, biomass energy can generate a great amount of hydrogen, carbon monoxide and methane with a little oxygen at a high temperature. The hydrogen-generating end is connected with a water gas shift device to effectively transform biomass energy into hydrogen energy. However, regarding the common hydrogen-rich water vapor transfer (i.e. fuel conversion in proton exchange membrane fuel cell (PEMFC) of automobile), the copper-based catalyst does not have stable performance at low temperature and is easy to lose catalytic activity after reaction. Moreover, the high-temperature iron-chromium (Fe—Cr) catalyst does not have activity high enough for fully completing reaction. In related researches, it shows that, concerning catalytic particles of copper (Cu), silver (Ag), gold (Au), zinc (Zn), cadmium (Cd), mercury (Hg), etc., because the d orbitals are fully filled and they have weak interactions with oxygen molecules, so that O—O bonds are difficult to break and, therefore, catalytic reactions with oxygen are less active. As comparing to platinum (Pt), the d orbital of Pt has fewer electrons; oxide can be easily formed; the surface atoms have neither strong nor weak bonding to oxygen atoms, so that O—O bond can be broken and oxides adhered on surface can be simultaneously reduced into water (Gattrell G. and MacDougall B., 2006. Handbook of Fuel Cells-Fundamentals, Technology and Applications, John Wiley & Sons Inc. New York, USA). Coordinated with auxiliary catalysts of cerium oxide (CeO₂) and cerium oxide/zirconium oxide (CeO₂/ZrO₂) (Hsu N.-Y. and Jeng K.-T., 2013. Reforming of natural gas using coking-resistant c atalyst for fuel cell system applications, Journal of Power Sources 222: 253-260), a solid/gas phase catalytic reaction can be established to improve energy efficiency. It shows that, by improving conventional catalysts, the energy and fuel crisis that human is facing can be solved.

Solid oxide fuel cell (SOFC) is considered as one of the most promising clean energy solution for the future. SOFC uses a solid oxide as electrolyte, where the solid oxide can transfer oxygen ions (O²⁻) at high temperature; hydrogen, natural gas, coal gas, etc. as anode fuel gas; and oxygen in the air as cathode oxidant. The main component of natural gas is methane, whose amount is about 85˜95 percents (%); and methane is a hydrocarbon containing the highest proportion of hydrogen and is thus able to generate hydrogen at the highest ratio. Common methane reformation reactions can be divided into steam reformation, autothermal reformation and partial oxidation, which are shown in Table 1. Therein, the maximum hydrogen amount per mole unit of methane can be generated through the steam reformation, where the required heat for reaction can just be obtained from the exhaust heat recycled from the SOFC on outputting power. Hence, the steam reformation has high energy efficiency while applying exhaust heat for effectively enhancing fuel conversion efficiency of cogeneration to 90%.

TABLE 1
Mode

| | | |
|---|---|---|
| Steam reformation | CH₄ + H₂O→CO + 3H₂; | >0 |
| | CO + H₂O→CO₂ + H₂ | |
| Autothermal reformation | 2CH₄ + O₂ + CO₂→3CO + 3H₂ + H₂O or | <0 |
| | 2CH₄ + O₂ + 2H₂O→4CO + 10H₂ | |
| Partial oxidation | 2CH₄ + O₂→2CO + 4H₂ | <0 |

Materials of common catalysts can be divided into ceramics, carbon and polymer (Antolini E., 2010. Composite materials: An emerging class of fuel cell catalyst supports, Applied Catalysis B: Environmental, 100: 413-426). Under a high temperature (800 celsius degrees (° C.)) in SOFC, carbon and polymer are corroded, but ceramics remain fairly stable; and, therefore, alumina (Al₂O₃) carrier is taken to be made into catalyst for processing methane reformation.

However, nickel-based reformation catalyst made of γ-alumina (γ—Al₂O₃) carrier for generating hydrogen may cause powder and coke, which makes the hydrogen-rich gas flow generated at the back end become unstable. The powder and coke may be even entered into the SOFC by gas pipeline and obstruct the system to become crashed, which has great impact on the surrounding equipments.

Hydrogen energy is one of the most ideal alternative energies in the future. In all fossil fuels, chemical fuels and biofuels, hydrogen has the highest heat value, which is up to 1.4×10⁵ kilo-joules per kilogram (kJ/kg) and three times to that of gasoline. Hydrogen can be fired in a large area, where the flame can be rapidly propagated and energy for ignition is low. Hence, hydrogen has a combustion efficiency value higher than fuel vehicle for 20%. Besides, methane is the hydrocarbon containing the highest proportion of hydrogen to be used in the hydrogen-generating reformation. Yet, the commercial catalysts in market may cause powder and coke to easily make stability decreased and even lose catalytic activity, which means poor overall efficiency on generating hydrogen.

Hence, the prior arts do not fulfill all users' requests on actual use.

### SUMMARY OF THE INVENTION

The main purpose of the present invention is to fabricate an annular carrier catalyst having low pipeline pressure drop, high catalytic activity and good mass transfer efficiency, which is quite suitable for gas reaction under a high space velocity.

Another purpose of the present invention is to effectively control methane steam reformation to form thermal equilibrium with coke on catalyst surface reduced for improving efficiency and prolonging life of battery while achieving good overall performance of the carrier catalyst.

To achieve the above purposes, the present invention is a method of fabricating an annular carrier catalyst, comprising steps of: (a) obtaining an annular carrier of γ—Al₂O₃ in a high-temperature furnace; passing air and raising a temperature to 1080˜1320° C. at a heating rate of 10° C. per minute (° C./min) to process calcination with the temperature maintained for 5˜7 hours (hr) afterwards; cooling down the temperature to a room temperature at a cooling rate of 10° C./min to obtain an annular carrier of α—Al₂O₃; (b) obtaining cerium nitrate (Ce(NO₃)₃.6H₂O) to be dissolved in deionized water to obtain a cerium nitrate solution; (c) impregnating and covering the annular carrier of α—Al₂O₃ with the cerium nitrate solution; (d) removing residual liquid in the cerium nitrate solution impregnated with the annular carrier of α—Al₂O₃ by a vacuum concentrator to obtain an annular carrier catalyst of CeO₂/α—Al₂O₃; (e) drying the annular carrier catalyst of CeO₂/α—Al₂O₃ in an oven; (f) obtaining the dried annular carrier catalyst of CeO₂/α—Al₂O₃ in a high-temperature furnace; passing air and raising a temperature to 440˜660° C. at a heating rate of 5° C./min to process calcination with the temperature maintained for 3˜5 hrs afterwards; (g) dissolving chloroplatinic acid in deionized water to obtain a platinum solution; (h) impregnating and covering the calcined annular carrier catalyst of CeO₂/α—Al₂O₃ with the platinum solution; (i) removing residual liquid in the platinum solution impregnated with the annular carrier catalyst of CeO₂/α—Al₂O₃ by a vacuum concentrator and drying the annular carrier catalyst of CeO₂/α—Al₂O₃ in an oven; and (j) obtaining the dried annular carrier catalyst of CeO₂/α—Al₂O₃ in a high-temperature furnace; passing air and raising a temperature to 520˜780° C. at a heating rate of 5° C./min to process calcination with the temperature maintained for 3˜5 hrs afterwards; and cooling down the temperature to a room temperature at a cooling rate of 5° C./min to obtain an annular carrier catalyst of Pt/CeO₂/α—Al₂O₃. Accordingly, a novel method of fabricating an annular carrier catalyst is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the view showing the annular carrier of α-alumina (α—Al₂O₃) before and after modification;

FIG. 3 is the view showing the change of surface area through a specific surface area analyzer (Brunauer-Emmett-Teller, BET);

FIG. 4 is the view showing the annular carrier catalyst and the commercial catalyst before and after methane reformation;

FIG. 5 is the view showing the methane conversion rates of the annular carrier catalyst with different platinum contents; and

FIG. 6 is the view showing the reaction durability of the annular carrier catalyst with different platinum contents.

### DESCRIPTION OF THE PREFERRED EMBODIMENTS

The following description of the preferred embodiment is provided to understand the features and the structures of the present invention.

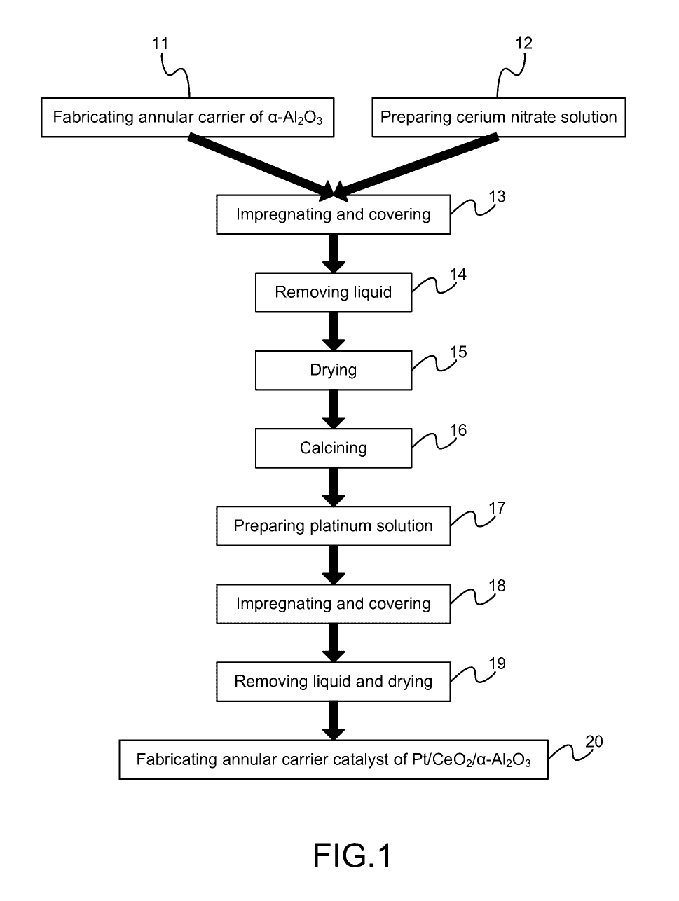

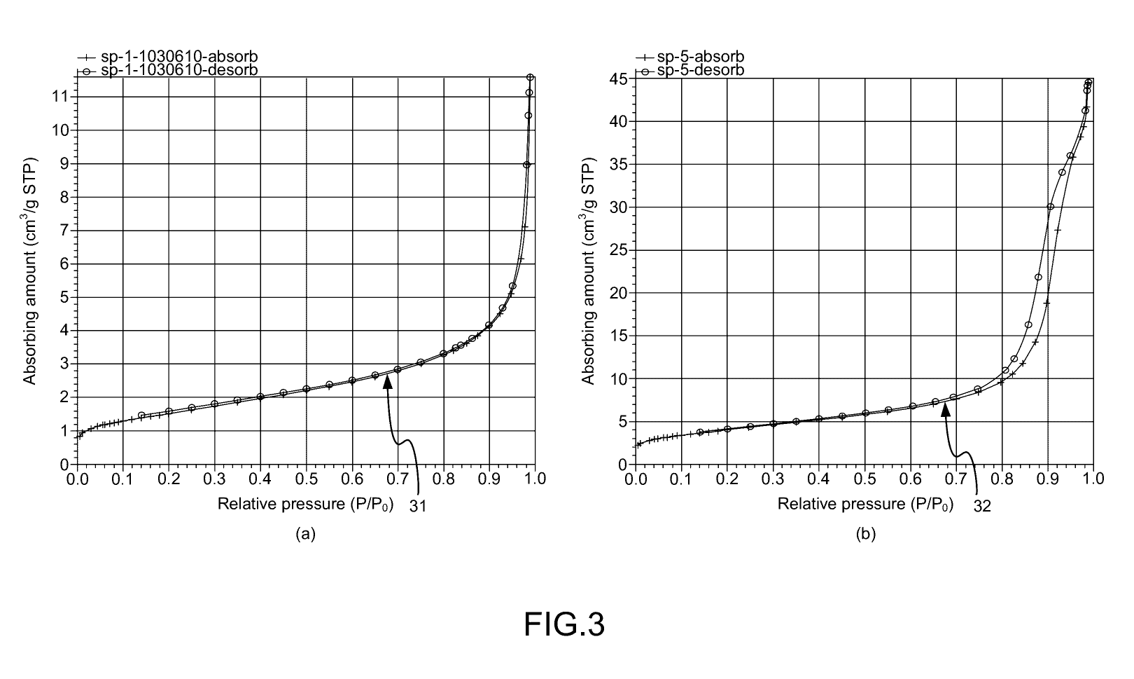

Please refer to FIG. 1˜FIG. 3, which are a flow view showing a preferred embodiment according to the present invention; a view showing an annular carrier of α—Al₂O₃ before and after modification; and a view showing a change of surface area through BET. As shown in the figures, the present invention is a method of fabricating an annular carrier catalyst. An annular carrier catalyst of 0.5% Pt/12% CeO₂/α—Al₂O₃ is fabricated through the following steps:

(a) Fabricating annular carrier of α—Al₂O₃ 11: At first, an annular carrier of γ-alumina (γ—Al₂O₃) mixed with 3 weight percents (wt. %) of carbon nanotubes (CNT) is put in a high-temperature furnace. By passing 3 liters per minute (LPM) of air, calcination is processed at a temperature of 1200 celsius degrees (° C.) obtained by a heating rate of 10° C. per minute (° C./min) and the temperature is maintained for 6 hours (hr) for calcination. Then, the temperature is cooled down to a room temperature at a cooling rate of 10° C./min to obtain a stable high-temperature annular carrier of α—Al₂O₃ having nano-pores.

(b) Preparing cerium nitrate solution 12: Cerium nitrate (Ce(NO₃)₃.6H₂O) is dissolved in deionized water to obtain a cerium nitrate solution.

(c) Impregnating and covering 13: The annular carrier of α—Al₂O₃ obtained in step (a) is impregnated and covered in the cerium nitrate solution obtained in step (b).

(d) Removing liquid 14: Residual liquid in the cerium nitrate solution impregnated with the annular carrier of α—Al₂O₃ is removed by a vacuum concentrator to obtain an annular carrier catalyst of cerium oxide/α—Al₂O₃ (CeO₂/α—Al₂O₃).

(e) Drying 15: The annular carrier catalyst of CeO₂/α—Al₂O₃ obtained after removing water is put in an oven to be dried at 110° C.;

(f) Calcining 16: The dried annular carrier catalyst of CeO₂/α—Al₂O₃ is put in a high-temperature furnace. By passing 3 LPM of air, the temperature is raised to 550° C. at a heating rate of 5° C./min to be calcined for 4 hrs.

(g) Preparing platinum solution 17: 0.53 g of chloroplatinic acid is dissolved in deionized water to obtain a platinum solution.

(h) Impregnating and covering 18: The annular carrier catalyst of CeO₂/α—Al₂O₃ calcined in step (f) is impregnated and covered in the platinum solution obtained in step (g).

(i) Removing liquid and drying 19: Residual liquid in the platinum solution impregnated with the annular carrier catalyst of CeO₂/α—Al₂O₃ is removed by a vacuum concentrator; and, then, the annular carrier catalyst of CeO₂/α—Al₂O₃ is dried in an oven.

(j) Fabricating annular carrier catalyst of Pt/CeO₂/α—Al₂O₃ 20: The annular carrier catalyst dried in step (i) is put in a high-temperature furnace. By passing 3 LPM of air, the temperature is raised to 650° C. at a heating rate of 5° C./min to be calcined with the temperature maintained for 4 hrs. Then, the temperature is cooled down to a room temperature at a cooling rate of 5° C./min to form an annular carrier catalyst of platinum/CeO₂/α—Al₂O₃ (Pt/CeO₂/α—Al₂O₃).

Thus, a novel method of fabricating an annular carrier catalyst is obtained.

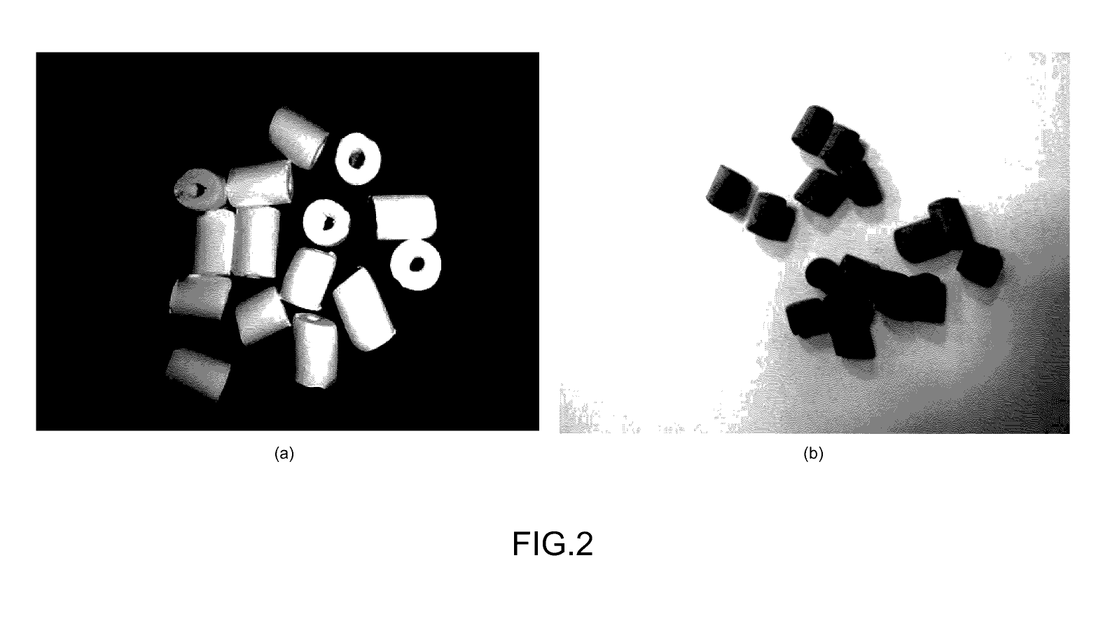

For enhancing surface area of the annular carrier of α—Al₂O₃ to increase reactivity, during fabricating the carrier catalyst as described above, the annular carrier of γ—Al₂O₃ mixed with 3 wt. % of CNTs are calcined at a high temperature to form the stable high-temperature annular carrier of α—Al₂O₃ having nano-pores. Then, the annular carrier of α—Al₂O₃ is impregnated with platinum nanoparticles and CeO₂ to complete structural modification of the reformation nano-catalyst. As shown in FIG. 2, for comparing with a pure annular carrier of α—Al₂O₃, image (a) shows a pure white annular carrier of α—Al₂O₃; and, after being made into an annular carrier catalyst, the color turns into gray-black in image (b). As shown in FIG. 3, surface areas of the carrier and the carrier catalyst are analyzed by Brunauer-Emmett-Teller (BET). The curves 31 in image (a) for the original annular carrier of α—Al₂O₃ show that the adsorption between gas molecule and solid is much smaller than the adsorption between gas molecules themselves. Once the gas molecules are adsorbed, the force between the adsorbed molecules and the desorbed molecules will aid the solid in absorbing gas molecules, where there is no significant difference between absorbing curve and desorbing curve. After the structural modification of the carrier catalyst with the CNTs, image (b) shows a BET analysis of the modified catalyst and it is found that, as following the increase in relative pressure (P/P₀), due to the pores in the modified catalyst, capillary occurs to rapidly increase the amount of gas molecules adsorbed. By analyzing the hysteresis of the desorbing curve, it is found that no flattening happens under a high relative pressure, which usually means that the carrier catalyst is full of slit-shaped holes with surface area effectively and dramatically increased. After measurement, the annular carrier catalyst of Pt/CeO₂/α—Al₂O₃ fabricated according to the present invention has a specific surface area of 130 square meters per gram (m²/g) with pores having an average diameter of 12.585 angstroms (Å), which is a relatively high surface area.

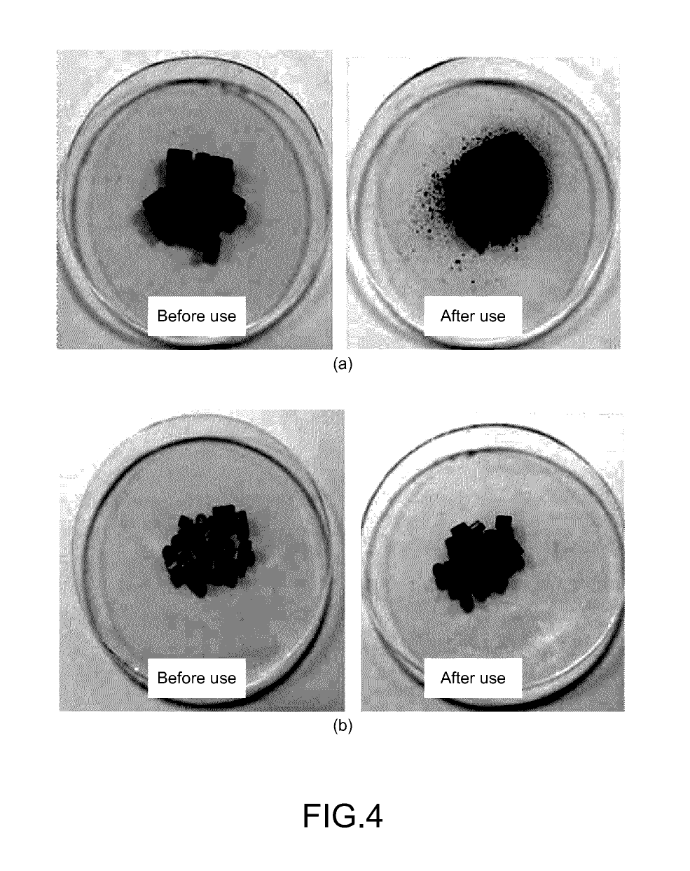

Please refer to FIG. 4, which is a view showing an annular carrier catalyst and a commercial catalyst before and after methane reformation. As shown in the figure, an annular carrier catalyst fabricated according to the present invention is compared with a commercial catalyst of Pt/CeO₂ through processing methane reformation. Therein, CeO₂ of the commercial catalyst has a particle size for obtaining best catalytic performance and slowing down carbon deposition. As a result shows, the commercial catalyst of Pt/CeO₂ in image (a) is coked after the reaction. The annular carrier catalyst of Pt/CeO₂/α—Al₂O₃ fabricated according to the present invention is kept almost the same before and after the reaction, which shows its excellent durability.

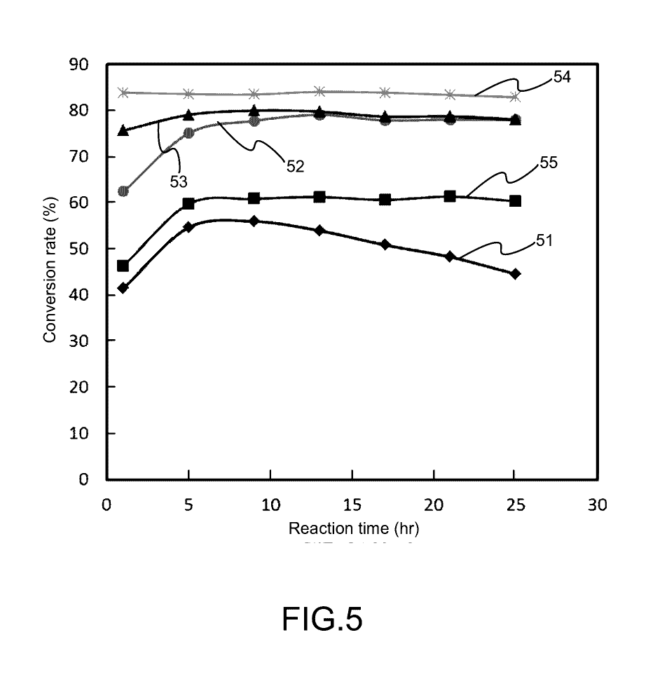

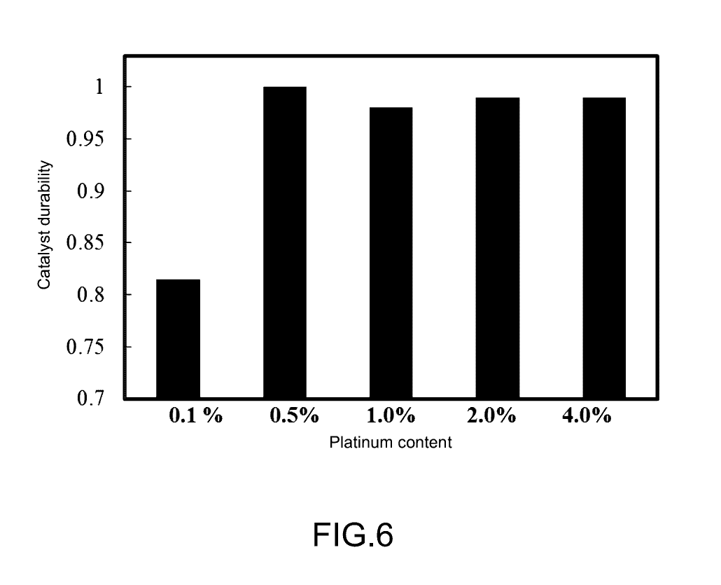

Please refer to FIG. 5 and FIG. 6, which are views showing methane conversion rates and reaction durability of an annular carrier catalyst with different platinum contents. As shown in the figures, as platinum accounts the largest part of cost of an annular carrier catalyst fabricated according to the present invention, the overall cost of the annular carrier catalyst can be effectively reduced by reducing the platinum content. Thus, methane conversion rates of the annular carrier catalyst are measured under various platinum contents of 0.1%, 0.5%, 1.0%, 2.0% and 4.0% for figuring out the best composition for the annular carrier catalyst.

After processing methane reformation reaction for 25 hrs, the methane conversion rates are shown in FIG. 5. Regarding the methane conversion rate of the annular carrier catalyst having the platinum content of 0.1% 51, its platinum content is too little to completely distribute platinum nanoparticles on the surface of the annular carrier catalyst. Methane molecules have to be adhered on the surface of the annular carrier catalyst for processing the reformation reaction. Hence, in the initial reaction period, as the reaction time increases, methane adsorption rate increases and the conversion rate is thus improved. After the methane reformation reaction, positions of platinum nanoparticles are rich in hydrogen to reduce Ce(IV) into Ce(III) and auxiliary media is thus lost its functions of oxygen storage and carbon emission and methane conversion rate is thus lowered. Regarding the conversion rates of the annular carrier catalyst separately having the platinum contents of 0.5% and 1.0% 52,53, in the initial reaction period, platinum content is still slightly insufficient to completely distribute platinum nanoparticles on the surface of the annular carrier catalyst. After methane molecules are effectively adhered on the surface of the annular carrier catalyst, the methane conversion rate is improved and its performance keeps the same afterwards. Regarding the conversion rate of the annular carrier catalyst having the platinum content of 2.0% 54, the result shows the best performance of a conversion rate of 84%. Regarding the conversion rate of the annular carrier catalyst having the platinum content of 4.0% 55, in the initial reaction period, because CeO₂ has a relatively low platinum content, a microstructure has to be built in the carrier catalyst to make auxiliary media release oxygen and effectively resolve carbon molecules on platinum surface for slightly improving the methane conversion rate. But, because the platinum content is too much and platinum nanoparticles aggregate to form a big granular size, the catalytic performance becomes poor.

Furthermore, for comparing long-term performances of the methane reformation reactions, after reacting for 5 hrs, reactions are stabilized for figuring out catalyst durability according to the methane conversion rates. As shown in FIG. 6, the annular carrier catalyst having the platinum content of 2% has the best conversion rate of 84%; yet, the performance declines slightly after reacting for 25 hrs. Although, the annular carrier catalyst having the platinum content of 0.5% has a conversion rate of 79% only, its cost can be greatly lowered with quite excellent durability.

Annular carriers and annular carrier catalysts with different compositions have significant differences in color. Therein, the annular carrier of α—Al₂O₃ is pure white. After α—Al₂O₃ is added with 12% of CeO₂, 12% CeO₂/α—Al₂O₃ becomes creamy-white owing to CeO₂. This annular carrier is further added with 0.1% or 0.2% of platinum nanoparticles. Because the platinum concentration is low, only a single layer of platinum nanoparticles are coated on the surface of the annular carrier to become 0.1% Pt/12%CeO₂/α—Al₂O₃ or 0.2% Pt/12% CeO₂/α—Al₂O₃.

However, if the platinum concentration is increased to 0.5%, 1.0%, 2.0%, or 4.0%, the surface of the annular carrier is covered by more than one layer of platinum nanoparticles to become 0.5% Pt/12% CeO₂/α—Al₂O₃, 1.0% Pt/12% CeO₂/α—Al₂O₃, 2.0% Pt/12% CeO₂/α—Al₂O₃ or 4.0% Pt/12% CeO₂/α—Al₂O₃, which is dark in appearance.

From the above results, it is found that the annular carrier catalyst fabricated according to the present invention has low pipeline pressure drop, high catalytic activity and good mass transfer efficiency, which is quite suitable for gas reaction under a high space velocity and is a key technology for solid oxide fuel cell (SOFC). The annular carrier catalyst uses an α—Al₂O₃ annular carrier in reformation to obtain more stable activity than γ—Al₂O₃ annular carrier. By analyzing catalyst characteristics and methane conversion rates for different components, it is found that the annular carrier catalyst of Pt/CeO₂/α—Al₂O₃ fabricated with the annular carrier of α—Al₂O₃ impregnated and coated with CeO₂ as accelerator and platinum nanoparticles as catalyst can significantly eliminate the traditional coke problem for commercial catalysts. The present invention further adds CNTs before calcining the annular carrier for finishing microstructure modification. Thus, the novel annular carrier catalyst obtains a specific surface area of 130 square meters per gram (m²/g) and an average pore diameter of 12.585 Å, which is a relatively high surface area. When the annular carrier catalyst contains 2.0% of platinum, the methane conversion rate is as high as 84%. Under the considerations of development cost and durability of catalyst, the annular carrier catalyst containing only 0.5% of platinum can achieve a methane conversion rate of 79%; and, after a long-term test of a 25 hrs reaction time, it is still able to maintain good catalytic reactivity.

To sum up, the present invention is a method of fabricating an annular carrier catalyst, where methane steam reformation can be effectively controlled to form thermal equilibrium with coke on catalyst surface reduced for improving efficiency and prolonging life of battery while achieving good overall performance of the carrier catalyst.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating an annular carrier catalyst, comprising steps of:
(a) obtaining an annular carrier of γ-alumina (γ—Al₂O₃) in a high-temperature furnace; passing air and raising a temperature to 1080˜1320 celsius degrees (° C.) at a heating rate of 10° C. per minute (° C./min) to process calcination with said temperature maintained for 5˜7 hours (hr); cooling down said temperature to a room temperature at a cooling rate of 10° C./min to obtain an annular carrier of α-alumina (α—Al₂O₃);
(b) obtaining cerium nitrate (Ce(NO₃)₃6H₂O) to be dissolved in deionized water to obtain a cerium nitrate solution;
(c) impregnating and covering said annular carrier of α—Al₂O₃ with said cerium nitrate solution;
(d) removing residual liquid in said cerium nitrate solution impregnated with said annular carrier of α—Al₂O₃ by a vacuum concentrator to obtain an annular carrier catalyst of cerium oxide/α-alumina (CeO₂/α—Al₂O₃);
(e) drying said annular carrier catalyst of CeO₂/α—Al₂O₃ in an oven;
(f) obtaining said dried annular carrier catalyst of CeO₂/α—Al₂O₃ in a high-temperature furnace; passing air and raising a temperature to 440˜660° C. at a heating rate of 5° C./min to process calcination with said temperature maintained for 3˜5 hrs;
(g) dissolving chloroplatinic acid in deionized water to obtain a platinum solution;
(h) impregnating and covering said calcined annular carrier catalyst of CeO₂/α—Al₂O₃ with said platinum solution;
(i) removing residual liquid in said platinum solution impregnated with said annular carrier catalyst of CeO₂/α—Al₂O₃ by a vacuum concentrator and drying said annular carrier catalyst of CeO₂/α—Al₂O₃ in an oven; and
(j) obtaining said dried annular carrier catalyst of CeO₂/α—Al₂O₃ in a high-temperature furnace; passing air and raising a temperature to 520˜780° C. at a heating rate of 5° C./min to process calcination with said temperature maintained for 3˜5 hrs; cooling down said temperature to a room temperature at a cooling rate of 5° C./min to obtain an annular carrier catalyst of platinum/cerium oxide/α-alumina (Pt/CeO₂/α—Al₂O₃).

2. The method according to claim 1,
wherein, in step (a), 3 weight percents (wt. %) of carbon nanotubes are mixed into said annular carrier of γ—Al₂O₃ to process calcination to obtain said annular carrier of α—Al₂O₃ having a plurality of nano-pores.

3. The method according to claim 1,
wherein, in step (a), by passing 3 liters per minute (LPM) of air, said temperature is raised to 1200° C. at a heating rate of 10° C./min to process calcination with said temperature maintained for 6 hrs.

4. The method according to claim 1,
wherein, in step (f), by passing 3 LPM of air, said temperature is raised to 550° C. at a heating rate of 5° C./min to process calcination for 4 hrs.

5. The method according to claim 1,
wherein, in step (j), by passing 3 LPM of air, said temperature is raised to 650° C. at a heating rate of 5° C./min to process calcination for 4 hrs.

6. The method according to claim 1,
wherein said annular carrier catalyst of Pt/CeO₂/α—Al₂O₃ has a specific surface area of 130 m²/g and an average pore diameter of 12.585 angstrons (Å).

7. The method according to claim 1,
wherein said annular carrier catalyst of Pt/CeO₂/α—Al₂O₃ has a platinum content of 0.51.0 percent (%).
